(19) United States
(12) Patent Application Publication
(10) Pub. No.: US 2015/0272314 A1
(43) Pub. Date: Oct. 1, 2015

(54) RESERVOIR HANDLE FOR A CLEANING ELEMENT SUCH AS A BRUSH, WIPER OR SIMILAR

(71) Applicant: WAAK-BW VZW, KUURNE (BE)

(72) Inventor: Kris VANDENBROUCKE, SINT-ELOOIS-WINKEL (BE)

(21) Appl. No.: 14/674,259

(22) Filed: Mar. 31, 2015

(30) Foreign Application Priority Data
Apr. 1, 2014 (BE) 2014/0222

(51) Int. Cl. A46B 11/00; B25G 3/36; A47L 13/26

(52) U.S. Cl. CPC A46B 11/0062; A47L 13/26; B25G 3/36

(57) ABSTRACT

Reservoir handle for a cleaning element (2) that is provided with a handle (3) in the form of a refillable reservoir (15) for liquid with a filler opening (14) and outlet (16, 33) with an operable valve (17) and an operating button (8) that can be pushed in axially to open the valve (17) to let liquid out of the reservoir (15), whereby the operating button (8) includes a stopper (25) for the reservoir (15) that is axially movable in the handle (3) between a closed position in which the reservoir (15) is closed when the operating button (8) is not pressed in and a filling position in which the reservoir (15) is connected to the environment via the filler opening (14) in order to be able to fill the reservoir (15).

The invention concerns a reservoir handle for a cleaning element such as a brush, wiper or similar that is fastened at the bottom of the reservoir handle.

Such a reservoir handle is known for example from BE 1.014.287 for use in a cleaning device of the type that is intended for cleaning a floor, in particular for cleaning by adding a liquid such as water and/or another liquid cleaning product that can be stored in the reservoir handle and which is then released according to need in order to make the floor wet or to apply a cleaning product or similar.

Such a known reservoir handle is provided with a handle that is formed as a refillable reservoir for liquid with a lateral filler opening at the top in order to be able to fill the reservoir, and an outlet more at the bottom that is closed by an operable valve, whereby means are provided to push open the valve in the form of an operating button that is connected to the valve via a rod, whereby the operating button is affixed movably in an axial direction on the handle and can be pressed in to open the valve in order to let liquid flow from the reservoir.

An advantage of such a reservoir handle with lateral filler opening is that the reservoir can easily be filled with water under a tap.

However, a disadvantage of such a reservoir handle is that, when it is filled with liquid, the handle must also be kept in a more or less upright position with the filler opening at the top in order to prevent the liquid being able to flow out unintentionally via the filler opening.

Another disadvantage that is found in practice with such a known reservoir handle is that the components are reasonably loose and consequently can rattle during cleaning, which can be irritating.

In the known reservoir handle, the operating button and the filler opening are affixed in a removable cap that is slid on the handle and which is sometimes removed to clean the reservoir handle, with the disadvantage that this cap and/or the operating button can sometimes become lost with all unpleasant consequences coupled thereto and whereby the reservoir handle becomes unusable for the application for which it is intended.

The purpose of the present invention is a reservoir handle that enables the aforementioned and other disadvantages to be remedied during use, or at least minimised, without affecting the known advantages, whereby such a reservoir handle is also easy to realise and is constructed such that it is practical to use.

To this end the invention concerns a reservoir handle of the aforementioned type whereby the operating button comprises a stopper for the reservoir that is axially movable on or in the handle or an extension piece thereof, between a closed position in which the reservoir is closed off from the environment when the operating button is not pressed in and a filling position in which the reservoir is connected to the environment via the filler opening to enable the filling of the reservoir.

With a reservoir handle according to the invention the operating button can also act as a stopper to close the lateral filler opening when the reservoir is filled with liquid, while in this closed position the operating button can nevertheless act as an operating button to let the liquid outside when necessary.

In this way it is possible to hold and use the reservoir handle in all possible directions, even upside down, without liquid being able to leak unintentionally from the reservoir handle.

Due to the integrated function of the operating button and stopper, a separate stopper is not needed to seal off the filler opening, such that such a valve cannot be lost and cannot interfere with the function of the operating button either.

With the intention of better showing the characteristics of the invention, a preferred embodiment of a reservoir handle according to the invention is described hereinafter by way of an example, without any limiting nature, with reference to the accompanying drawings, wherein:

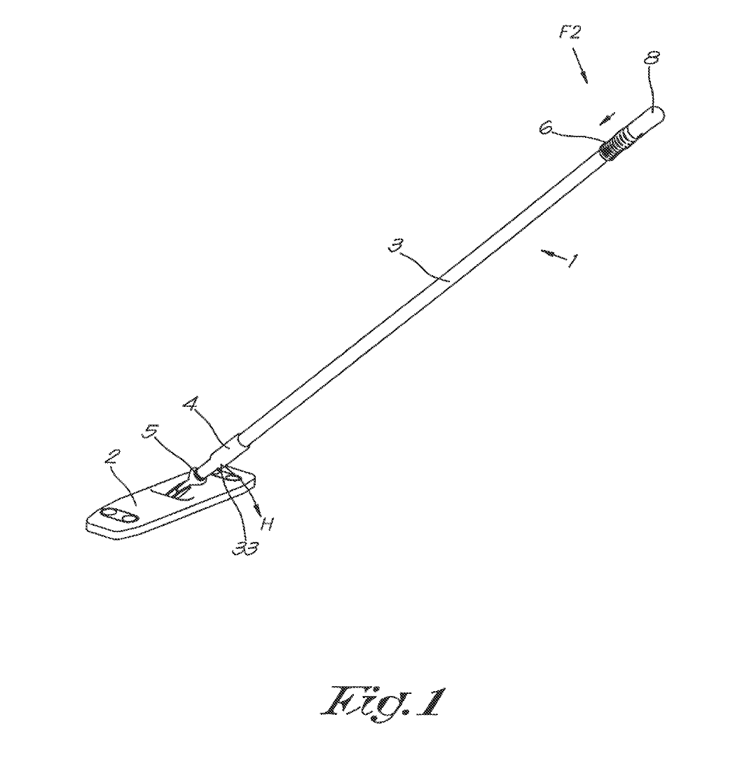

FIG. 1 schematically shows a perspective view of a reservoir handle according to the invention in a ready-to-use state equipped with a cleaning element for cleaning a floor;

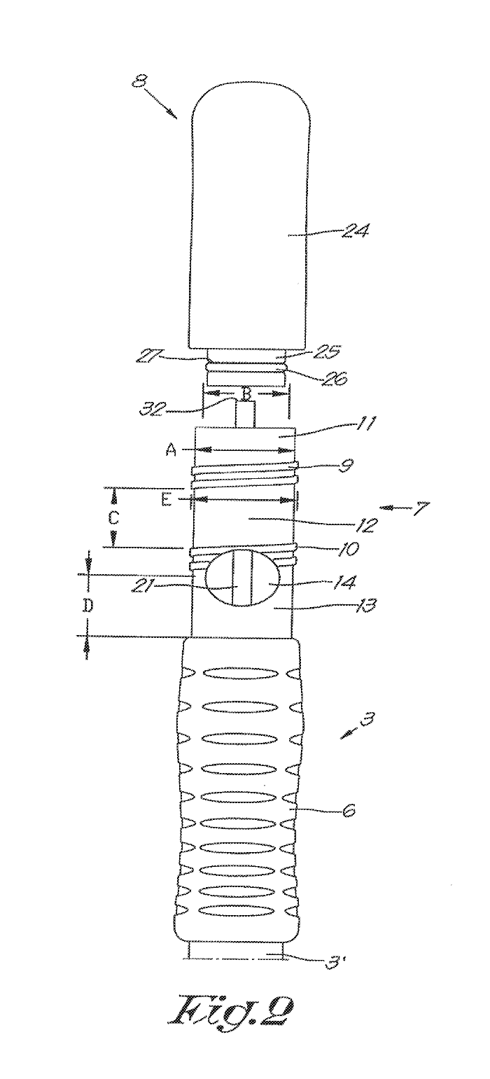

FIG. 2 shows a top view of the handgrip of the reservoir handle of FIG. 1 on a larger scale, in an exploded view;

FIG. 3 shows a longitudinal cross-section of the reservoir handle of FIG. 1 in the exploded view of FIG. 2;

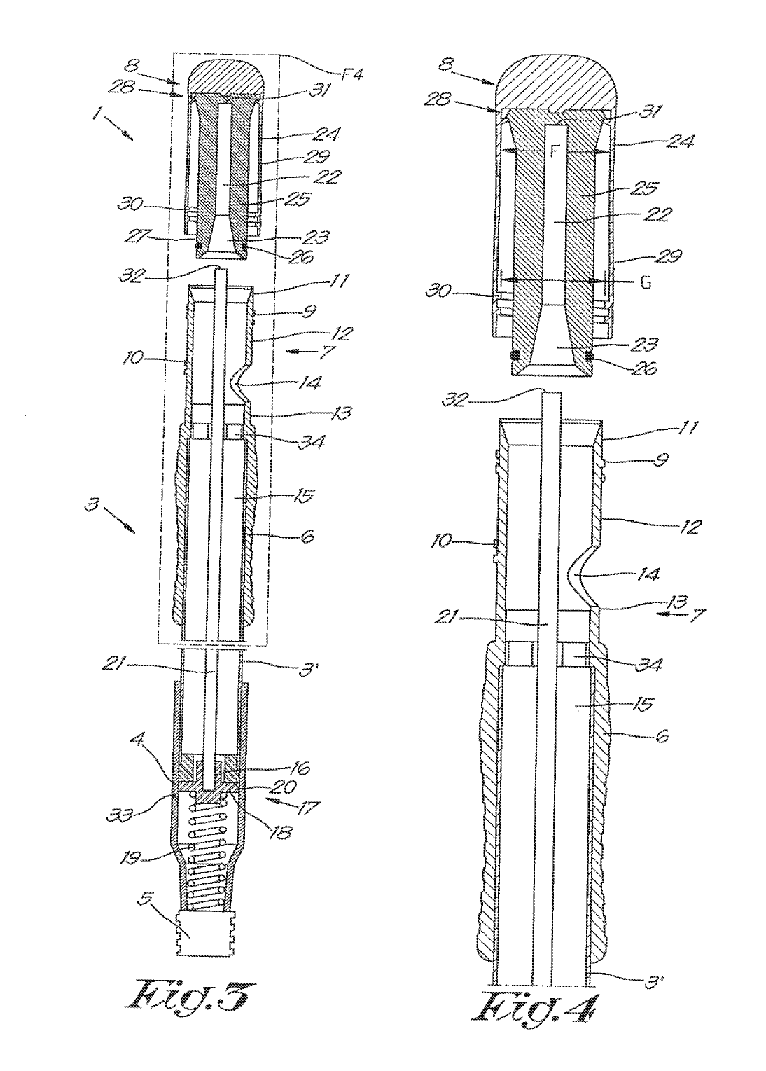

FIG. 4 shows the section indicated by F4 in FIG. 3 on a larger scale;

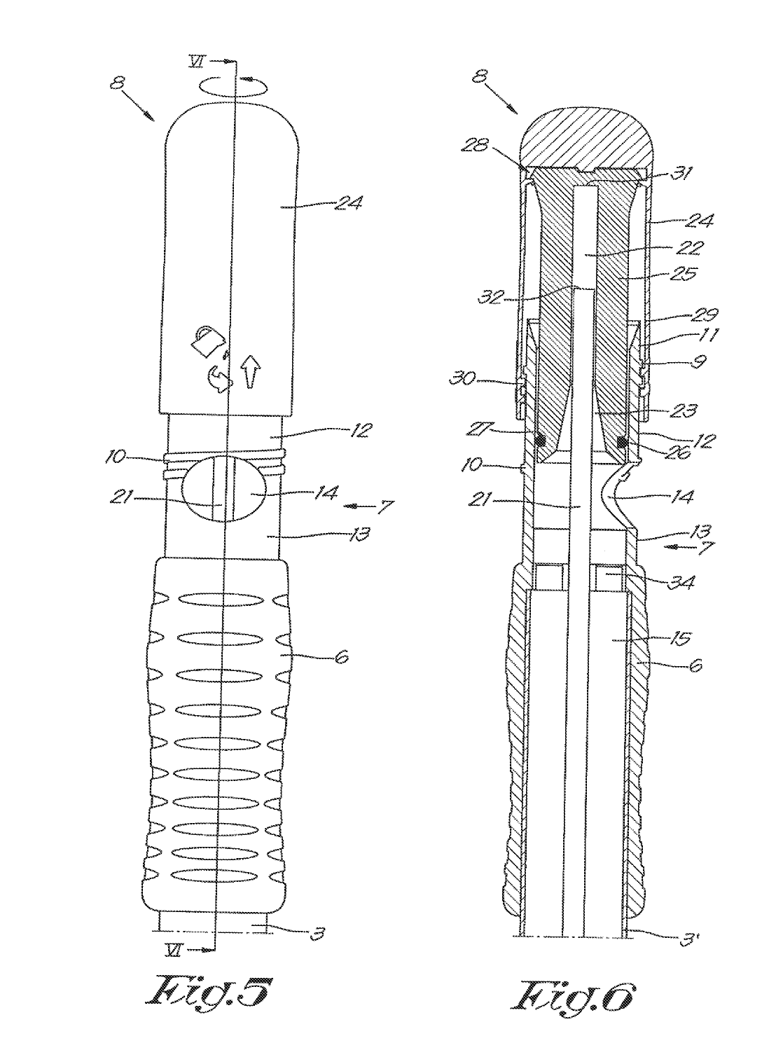

FIGS. 5 and 6 are analogous to FIGS. 2 and 4, but for a filled state of the reservoir handle;

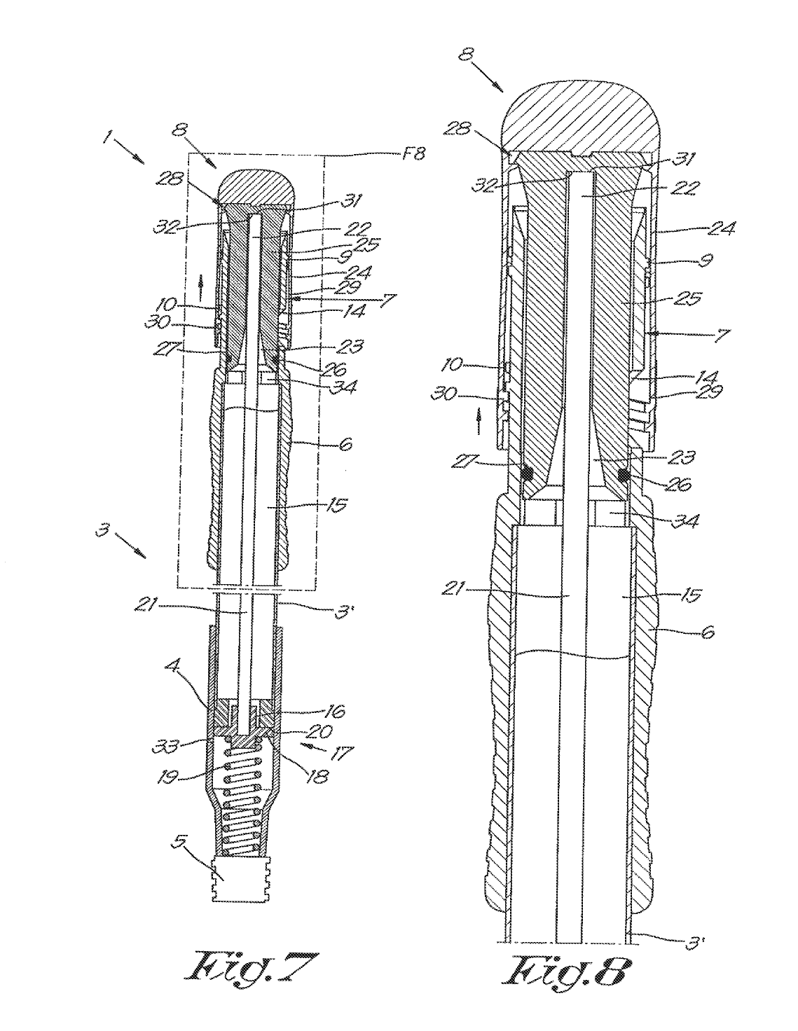

FIG. 7 shows a longitudinal cross-section of the reservoir handle of FIG. 1 in the ready-to-use state of FIG. 1;

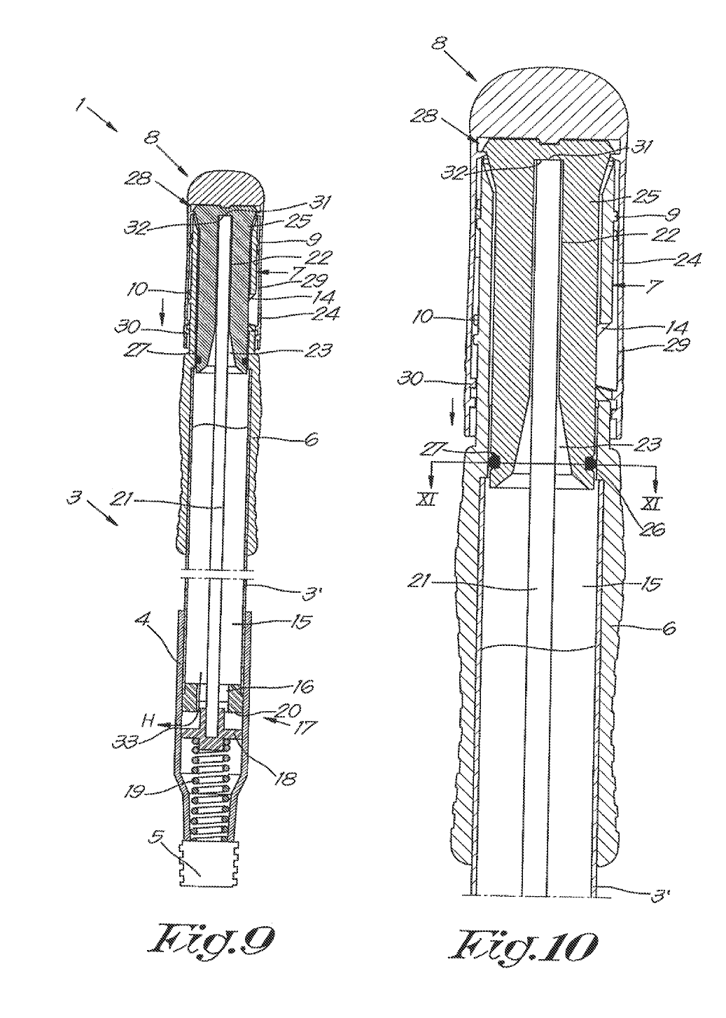

FIG. 8 shows the section indicated by F8 in FIG. 7 on a larger scale;

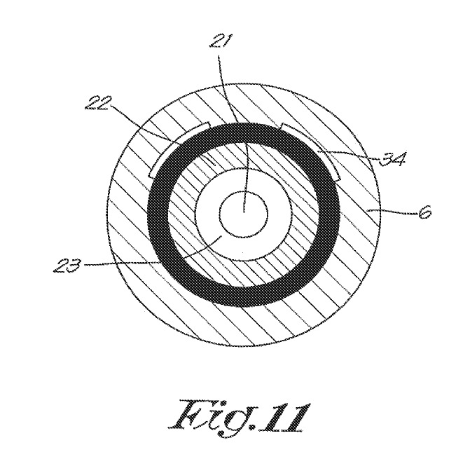

FIGS. 9 and 10 are analogous drawings to FIGS. 7 and 8, but in a situation in which the operating button has been pushed in to let liquid out of the reservoir;

FIG. 11 shows a transverse cross-section according to line XI-XI in FIG. 10.

The reservoir handle 1 according to the invention shown in FIG. 1 is in this case provided with a known cleaning element 2 to which a floorcloth or cleaning cloth or similar can be fastened for cleaning a floor.

As can be seen in the cross-section of FIG. 3, in this case the reservoir handle 1 is essentially formed from a handle 3 in the form of a hollow tube 3′ that is provided at the bottom with an end piece with a coupling piece 5 for fastening the cleaning element 2, and is provided on top with a handgrip 6 with a tubular cylindrical extension piece 7 with outside diameter A and inside diameter B that extends in an axial direction and as it were forms an extension of the handle on which an operating button 8 can be affixed.

On the extension piece 7 of the handle 3, referring to FIG. 2, two short threaded sections of a few windings are provided at an axial distance C from one another, respectively a first threaded section 9 and a second threaded section 10 that is located closer, with respect to the first threaded section 9, to the end piece 4 at the bottom end of the handle 3 and at a distance D from the handgrip 6.

The threaded sections 9 and 10 have an outside diameter E that is greater than the outside diameter A of the extension piece 7 and as it were are on top of the outer surface of the extension piece 7 of the handle 3 such that it protrudes radially with respect to this outside surface.

The threaded sections 9 and 10 divide the extension piece 7 into three coaxial cylindrical zones with outside diameter A without screw thread, i.e. a zone 11 at the top end of the extension piece 7, a zone 12 between the two threaded sections 9 and 10, and a zone 13 between the second threaded section and the handgrip 6.

A lateral filler opening 14 is provided in the extension piece 7, which in this case is at the location of the bottom zone 13 of the extension piece and partially overlapping in the second threaded section 10.

The orientations such as bottom, top and similar in the context of the description must be viewed for a reservoir handle 1 that is oriented upwards in use, as shown in FIG. 1 with the handgrip 6 at the top.

The hollow handle 3 forms a reservoir 15 for a liquid, and to this end is provided at the bottom in a known way with an outlet 16 that is closed by a valve 17 in the form of a disk 18 that is pressed against a seat 20 of the valve 17 by means of a compression spring 19 to obtain a leak-free seal of the outlet 16, whereby the compression spring 19 is in the end piece 4.

The disk 18 of the valve 17 can be operated by means of a rod 21 that extends through the reservoir 15 and the handgrip 6 with extension piece 7.

The operating button 8 is provided with a central guide, in this case in the form of a bore 22, by which the operating button 8 can be slid over the top end of the rod 21, whereby the bore 22 is provided with a conical entrance 23 in order to guide the rod 21 into the bore when affixing the operating button 8 on the rod 21.

The operating button 8 is composed of a cap 24 that can be affixed over the extension piece 7 and a cylindrical stopper 25 coaxially fastened therein for closing the reservoir 15 at the top, whereby in this case this stopper 25 is provided at its base with a seal 26 in the form of an O-ring that is affixed in a peripheral groove 27 of the stopper 25, and which is provided at the head with a snap connector 28 with which the stopper 25 can be snapped in the cap 24 in a way that the stopper 25 is locked in an axial direction in the cap 24, but a turning movement of the stopper 25 in the cap 24 still remains possible.

The cap 24 is constructed with a cylindrical shell 29 with inside diameter F in which a threaded section 30 is provided at the bottom that can mate with the threaded sections 9 and 10 of the extension piece 7 of the handle 3, whereby this threaded section 30 in the cap 24 has an inside diameter G that is somewhat larger than the outside diameter A of the zones 11, 12 and 13 of the extension piece 7, and whereby this threaded section 30 protrudes inwards radially with respect to the inside surface of the shell 29.

During assembly of the reservoir handle 1 according to the invention, the stopper of the operating button 8 is slid over the top end of the rod 22 and the cap 24 is affixed over the zone 11 of the extension piece 7, after which the cap 24 is screwed, via a first screwed connection, between its threaded section 30 and the first threaded section 9 of the handle 3, as shown in FIGS. 5 and 6.

In this situation the stopper 25, more specifically the seal 26 of the stopper 25, is completely above the filler opening 14 such that the reservoir 15 can be filled, for example by keeping the reservoir handle 1 with its filler opening 14 under a tap.

For filling, the cap 24 can be further screwed down until the threaded section 30 of the cap 24 goes past the first threaded section 9 of the handle 3 up to this zone 12 between the two threaded sections 9 and 10. In this situation the cap 24 can be moved over a distance C along the handle 3, whereby the movement is limited by the threaded sections 9 and 10 of the handle 3 forming an end stop for the threaded section 30 of the cap 24.

For filling, in this situation the cap 24 can be slid upwards to a maximum until the first threaded section 9 of the handle 3 forms an end stop for the threaded section 30 of the cap.

In principle, after the first assembly of the reservoir handle 1, the cap 24 is never screwed more on the first threaded section 9 so that the cap 24 can always remain mounted on the handle 3 and does not need to be unintentionally removed from the reservoir handle 1, and thereby cannot get lost.

Once the reservoir 15 has been sufficiently filled, this reservoir 15 is closed by pushing the stopper 25 deeper into the extension piece 7 of the handle 3 by now screwing on the cap 24 with the second screwed connection between the second threaded section 10 and the threaded section 30 until the threaded section 30 of the cap 24 goes past the second threaded section 10 into the zone 13, as shown in FIGS. 7 and 8.

The length of the rod 21 and the depth of the bore 22 are preferably chosen such that when the threaded section 30 of the cap 24 just passes the second threaded section 10 of the handle 3, the base 31 of the bore 22 does not quite touch the head 32 of the rod 21, preferably with a small clearance of one millimetre for example to prevent the disk 18 from being pushed open by the rod 21 when screwing on the cap 24 with the second screwed connection.

It is clear that is in this situation of FIGS. 7 and 8, the stopper 25 completely closes the reservoir at the top and prevents liquid from being able to leak out of the reservoir 15 to the outside via the filler opening 14, not even when the reservoir handle 1 is held upside down.

In the situation of FIGS. 7 and 8 it is possible to push in the operating button 8 axially over a maximum distance D corresponding to the height of the zone 13, if applicable limited to the travel of the disk 18 of the valve 17 if this is smaller than the maximum distance D.

When pushing in, the disk 18 is pushed downwards by the rod 21 such that the valve 17 opens, as shown in FIGS. 9 and 10, and the liquid can escape from the reservoir 15 to the outside via the outlet 16 and an outlet 33 in the end piece 4, as shown by arrow H in FIG. 9 and in FIG. 1 in order to moisten the floor or to apply a detergent or similar.

In this situation the seal 26 of the stopper 25 is in the bottom section of the extension piece 7, just above the top end of the tube 3′ at a place where cutaways 34 are provided in the inside surface with diameter B, which can be seen in the cross-sections of FIGS. 11 and 8, and which ensure that in this position of the seal 26, the reservoir 15 is connected to the environment via the filler opening 14 to allow air into the reservoir 15 to prevent a vacuum forming above the level of the liquid, that would otherwise prevent the outflow of the liquid through the outlets 16 and 33.

When sufficient liquid has come out of the reservoir 15 onto the floor, the operating button 8 can be released again, such that the spring 19 pushes the disk 18 upwards against the seat 20 and thereby also pushes the rod 21 and the stopper 25 of the operating button 8 upwards to the position of FIG. 8, whereby the stopper 25 is above the cutaways 24 and closes the reservoir 15 and whereby the second threaded section 10 and the threaded section 30 mating therewith almost come into abutment against one another.

It is clear that alternatively the first and second threaded sections 9 and 10 can also be provided on the cap 24, and the screw thread 30 mating therewith can be provided on the handle 3.

It is clear that the threaded sections 9 and 10 can also be provided directly on the tube 3′ of the handle and thus the filler opening 14 can also be provided directly in the tube 3′ of the handle 3, in which case a separate extension piece 7 would not be required.

The advantage of the extension piece 7 is that it can be made of plastic as a single injection moulded part, whether or not together with the handgrip 6.

It is not excluded that the threaded sections 9, 10 and 30 are provided between the inside surface of the handle 3 or its extension piece 7 and the outside surface of the stopper 25, instead of between the inside surface of the stopper 24 and the outside surface of the handle 3.

Instead of providing two separate threaded sections 9 and 10, it is also possible to integrate both threaded sections into one continuous screw thread that runs through the zone 12.

Instead of a mechanical rod connection between the operating button 8 and the valve 17, an electrical connection is not excluded, whereby in that case the valve 17 would be an electric valve that is connected to a switch on top of the handle 3, whereby this switch is operated by the operating button 8 with integrated stopper 25.

It goes without saying that in this last case a power source will be needed, for example in the form of a battery that can also be used to operate a pump that could be connected to a sprayer or similar.

The present invention is by no means limited to the embodiment described as an example and shown in the drawings, but such a reservoir handle according to the invention for a brush, cloth or similar, can be realised according to different variants, without departing from the scope of the invention.

1. Reservoir handle for a cleaning element (2) at the bottom such as a brush, wiper or similar, whereby this reservoir handle (1) is provided with a handle (3) that is formed as a refillable reservoir (15) for liquid with a lateral filler opening (14) at the top and an outlet (16, 33) more at the bottom that is closed by an operable valve (17) and an operating button (8) that is connected to the valve (17), and which is affixed movably in the axial direction on the handle (3) and can be pushed in axially to open the valve (17) to let liquid out of the reservoir (15), wherein the operating button (8) comprises a stopper (25) for the reservoir (15) that is axially movable on or in the handle (3) or an extension piece (7) thereof, between a closed position in which the reservoir (15) is closed off from the environment when the operating button (8) is not pressed in and a filling position in which the reservoir (15) is connected to the environment via the filler opening (14) in order to be able to fill the reservoir (15).

2. Reservoir handle according to claim 1, wherein the top end of the handle (3) or an extension piece (7) thereof is constructed as a cylindrical tubular form and that the stopper (25) is provided with a seal (26) for sealing the stopper (25) in the handle (3), whereby the stopper (25) is affixed movably in the axial direction in this end of the handle (3).

3. Reservoir handle according to claim 2, wherein the operating button is provided with a cap (24) that fits over the aforementioned top end of the handle (3) and which is connected to the stopper (25).

4. Reservoir handle according to claim 2, further comprising a first screwed connection between the handle (3) and the operating button (8) to be able to screw the operating button (8) on the handle (3) during assembly.

5. Reservoir handle according to claim 4, further comprising a second screwed connection between the handle (3) and the operating button (8) to be able to move the stopper (25) axially in the handle (3) until the seal (26) of the stopper (25) is below the level of the filler opening (14), corresponding to the aforementioned closed position.

6. Reservoir handle according to claim 5, wherein the operating button (8), or the handle (3), is provided with a threaded section (30) that can mate with a first threaded section (9) on the handle (3), or operating button (8), to form the first screwed connection (9-30), and together with a second threaded section (10) on the handle (3), or operating button (8), to form the second screwed connection (10-30), whereby the first and second threaded sections (9 and 10) are at an axial distance (C) from one another.

7. Reservoir handle according to claim 6, wherein the second threaded section (10) is located closer to the bottom end of the handle (3) than the first threaded section (9).

8. Reservoir handle according to claim 6, wherein the second threaded section (10) and the threaded section (30) mating therewith are positioned on the handle (3) and on the operating button (8) such that, when the second threaded section (10) is screwed in the bottom end of the handle (3) past the threaded section (30) mating therewith, the operating button (8) can be pressed over a certain distance to be able to use this operating button (8) to open the aforementioned valve (17) during use for cleaning.

9. Reservoir handle according to claim 8, wherein the filler opening (14) at least partially extends in the axial direction below the second threaded section (10).

10. Reservoir handle according to claim 3, wherein the threaded sections (9, 10 and 30) of the screwed connections (9-30 and 10-30) are provided on the outside surface of the handle (3) and on the inside surface of the cap (24).

11. Reservoir handle according to claim 10, wherein the threaded sections (9, 10 and 30) of the screwed connections (9-30 and 10-30) protrude out of the aforementioned surfaces.

12. Reservoir handle according to claim 10, wherein the inside diameter (G) of the threaded sections (30) on the cap (24) is equal to or somewhat greater than the outside diameter (A) of the outside surface of the handle and/or the outside diameter (E) of the threaded sections (9, 10) on the handle (3) is equal to or somewhat smaller than the inside diameter (F) of the inside surface of the cap (24).

13. Reservoir handle according to claim 1, wherein the operating button (8) is connected to the valve (17) by means of a rod (21) that extends through the reservoir (15) and which is movably held by one end in an axial guide (22) of the operating button (8).

14. Reservoir handle according to claim 13, wherein the axial guide (22) is a close-tolerance bore with a widened conical entrance (23).

15. Reservoir handle according to claim 14, wherein the aforementioned valve (17) is provided with a disk (18) that is operated by the rod (21) and which is pushed against a seat (20) by means of a spring (19) in order to keep the valve (17) closed, and the length of the rod (21) and the depth of the guide (22) are harmonised to one another such that the rod pushes the operating button (8) upwards due to the action of the spring (19) up to a position whereby the second threaded section (10) and the threaded section (30) mating therewith almost or do come into abutment against one another, and whereby the seal (26) is below the level of the filler opening (14).

16. Reservoir handle according to claim 15, wherein one or more cutaways (34) are provided in the inside wall of the cylindrical end of the handle (3) below the aforementioned level of the seal (26) that ensure that when the seal passes such a cutaway, when the operating button (8) is pressed in to open the valve (17), the reservoir (15) is connected to the environment via the filler opening (14).

17. Reservoir handle according to claim 3, further comprising a first screwed connection between the handle (3) and the operating button (8) to be able to screw the operating button (8) on the handle (3) during assembly.

18. Reservoir handle according to claim 7, wherein the second threaded section (10) and the threaded section (30) mating therewith are positioned on the handle (3) and on the operating button (8) such that, when the second threaded section (10) is screwed in the bottom end of the handle (3) past the threaded section (30) mating therewith, the operating button (8) can be pressed over a certain distance to be able to use this operating button (8) to open the aforementioned valve (17) during use for cleaning.
